(19) United States
(12) Patent Application Publication
(10) Pub. No.: US 2026/0229435 A1
(43) Pub. Date: Aug. 6, 2026

(54) ARC PATH FORMATION UNIT AND DIRECT CURRENT RELAY COMPRISING SAME

(71) Applicant: LS E-MOBILITY SOLUTIONS CO., LTD., Cheongju-si, Chungcheongbuk-do (KR)

(72) Inventor: Jung Woo YOO, Cheongju-si, Chungcheongbuk-do (KR)

(21) Appl. No.: 19/158,284

(22) PCT Filed: Dec. 21, 2023
(86) PCT No.: PCT/KR2023/021282

§ 371 Date: Aug. 20, 2025

(30) Foreign Application Priority Data
Mar. 14, 2023 (KR) 10-2023-0033300

(51) Int. Cl. H01H 50/38

(52) U.S. Cl. CPC H01H 50/38

(57) ABSTRACT

The present disclosure provides an arc path formation unit, which can effectively guide a generated arc to the outside, and a direct current relay comprising same, the arch path formation unit comprising: a magnetic frame; and a Halbach array arranged to be adjacent to the inner circumferential surface of the magnetic frame so as to form a magnetic field inside the magnetic frame, wherein the Halbach array includes first, second and third blocks, which are arranged to be parallel in one direction, and the first block has a surface facing the third block, which is magnetized with a polarity opposite to that of the surface of the third block facing the first block.

### CROSS-REFERENCE TO RELATED APPLICATIONS

This application is the National Stage filing under 35 U.S.C. 371 of International Application No. PCT/KR 2023/021282, filed on Dec. 21, 2023, which claims the benefit of earlier filing date and right of priority to Korean Application No. 10-2023-0033300, filed on Mar. 14, 2023, the contents of which are all hereby incorporated by reference herein in their entirety.

### FIELD

The disclosure relates to an arc path formation unit and a direct current (DC) relay including the same, and more particularly, to an arc path formation unit capable of efficiently guiding a generated arc to outside, and a DC relay including the same.

### BACKGROUND

A direct current (DC) relay is a device that transmits a mechanical driving signal or a current signal using the principle of an electromagnet. The DC relay is also called a magnetic switch and is generally classified as an electrical circuit switching device.

A DC relay includes a fixed contact and a movable contact. The fixed contact is electrically connected to an external power supply and a load. The fixed contact and the movable contact may be brought into contact with or separated from each other.

By the contact and separation between the fixed contact and the movable contact, electrical connection or disconnection through the DC relay is achieved. Such movement, like the contact or separation, is made by a drive unit that applies a driving force.

When the fixed contact and the movable contact are separated from each other, an arc is generated between the fixed contact and the movable contact. The arc is a flow of high-pressure and high-temperature current. Accordingly, the generated arc must be rapidly discharged from the DC relay through a preset path.

An arc discharge path is formed by magnets provided in the DC relay. The magnets produce magnetic fields in a space where the fixed contact and the movable contact are in contact with each other. An electromagnetic force generated by the produced magnetic fields and the flow of current forms a discharge path of the arc.

However, in case that the generated arc is not immediately moved to the outside or is not sufficiently extinguished until it is moved to the outside, there is a possibility that the internal components of the DC relay may be damaged by the energy of the arc.

A shaft, a spring member, and the like, which drive a movable contact to move up and down, are arranged in a central portion of the DC relay, namely, a space between different fixed contacts. Thus, in case that the generated arc moves toward the central portion, these members may be damaged.

Therefore, it may be considered to develop an arc path formation unit, which is capable of quickly extinguishing and discharging a generated arc to outside, and a DC relay including the same.

Korean Registration Application No. 10-1216824 discloses a DC relay. Specifically, a DC relay capable of suppressing arbitrary separation between a movable contact and a fixed contact using a damping magnet is disclosed.

However, this type of DC relay does not disclose a structure for forming a discharge path for an arc which is generated when the fixed contact and the movable contact are separated.

Korean Registration Application No. 10-1696952 discloses a DC relay. Specifically, a DC relay capable of suppressing the movement of a movable contact using a plurality of permanent magnets is disclosed.

However, this type of DC relay does not disclose a structure for controlling a direction of an arc discharge path.

Korean Registration Application No. 10-1696952 (Dec. 28, 2012)

Korean Registration Application No. 10-1696952 (Jan. 16, 2017)

### SUMMARY

One aspect of the disclosure is to provide an arc path formation unit capable of efficiently extinguishing and discharging a generated arc, and a direct current (DC) relay including the same.

Another aspect of the disclosure is to provide an arc path formation unit, which is capable of suppressing damage to various components arranged adjacent to a center region for operation of a DC relay, and a DC relay including the same.

Another aspect of the disclosure is to provide an arc path formation unit, which is capable of more precisely adjusting direction and intensity of magnetic fields for discharging an arc, and a DC relay including the same.

Technical problems to be solved by the disclosure are not limited to the above-mentioned technical problems, and other drawbacks not mentioned herein will be clearly understood from the following description by those skilled in the art to which the disclosure pertains.

To achieve the above aspects and other advantages according to one or more embodiments, an arc path formation unit includes: a magnetic frame having a space portion formed therein in which a fixed contact and a movable contact are accommodated; and a Halbach array including a plurality of blocks producing magnetic fields in the space portion, arranged adjacent to an inner circumferential surface of the magnetic frame, arranged in parallel in one direction, and formed of a magnetic material, wherein the Halbach array includes: a first block; a second block arranged to overlap the first block in the one direction; and a third block located to face the first block with the second block arranged therebetween, and a surface, facing the third block, of the first block is magnetized with a polarity opposite to that of a surface, facing the first block, of the third block.

The Halbach array may include: a first Halbach array arranged adjacent to one surface of the magnetic frame; and a second Halbach array arranged adjacent to another surface of the magnetic frame, and located to face the first Halbach array with the fixed contact and the movable contact arranged therebetween, and the first Halbach array and the second Halbach array may each include the first block, the second block, and the third block.

The space portion may be formed such that a length thereof in the one direction is smaller than a length in another direction, the first block, the second block, and the third block included in the first Halbach array may be arranged to overlap in the another direction the first block, the second block, and the third block included in the second Halbach array, respectively, and a surface, facing the second block, of the first block included in the first Halbach array may be magnetized with a same polarity as that of a surface, facing the second block, of the first block included in the second Halbach array.

The second block included in the first Halbach array and the second block included in the second Halbach array may be magnetized with opposite polarities on corresponding surfaces thereof facing the fixed contact and the movable contact.

The second block included in the first Halbach array and the second block included in the second Halbach array may be magnetized with a same polarity on corresponding surfaces thereof facing the fixed contact and the movable contact.

The magnetic frame may include spacers each arranged on the inner circumferential surface of the magnetic frame between two adjacent blocks of the Halbach array, protruding in a direction away from the inner circumferential surface of the magnetic frame, and formed such that a thickness thereof in the one direction corresponds to a gap between the two adjacent blocks, two different spacers may be located to face each other with one block included in the Halbach array arranged therebetween, and a gap between the two different spacers may correspond to a length of the one block in the one direction.

At least one of the first block, the second block, and the third block may extend in a direction crossing the one direction.

According to one or more embodiments, a direct current (DC) relay includes: a plurality of fixed contacts located with being spaced apart from each other; a movable contact brought into contact with or separated from the fixed contacts; a magnetic frame having a space portion formed therein in which the fixed contacts and the movable contact are accommodated; and a Halbach array including a plurality of blocks producing magnetic fields in the space portion, arranged adjacent to an inner circumferential surface of the magnetic frame, arranged in parallel in one direction, and formed of a magnetic material, wherein the Halbach array includes: a first block; a second block arranged to overlap the first block in the one direction; and a third block located to face the first block with the second block arranged therebetween, and a surface, facing the third block, of the first block is magnetized with a polarity opposite to that of a surface, facing the first block, of the third block.

The Halbach array may include: a first Halbach array arranged adjacent to one surface of the magnetic frame; and a second Halbach array arranged adjacent to another surface of the magnetic frame, and located to face the first Halbach array with the fixed contacts and the movable contact arranged therebetween, and the first Halbach array and the second Halbach array may each include the first block, the second block, and the third block.

The space portion may be formed such that a length thereof in the one direction is smaller than a length in another direction, the first block, the second block, and the third block included in the first Halbach array may be arranged to overlap in the another direction the first block, the second block, and the third block included in the second Halbach array, respectively, and a surface, facing the second block, of the first block included in the first Halbach array may be magnetized with a same polarity as that of a surface, facing the second block, of the first block included in the second Halbach array.

The magnetic frame may include spacers each arranged on the inner circumferential surface of the magnetic frame between two adjacent blocks of the Halbach array, protruding in a direction away from the inner circumferential surface of the magnetic frame, and formed such that a thickness thereof in the one direction corresponds to a gap between the two adjacent blocks, two different spacers may be located to face each other with one block included in the Halbach array arranged therebetween, and a gap between the two different spacers may correspond to a length of the one block in the one direction.

At least one of the first block, the second block, and the third block may extend in a direction crossing the one direction.

Among various effects of the disclosure, effects that can be obtained through the solution to problems will be described as follows.

First, an arc path formation unit according to the disclosure includes a magnetic frame and a Halbach array. The Halbach array includes a plurality of magnetic bodies arranged in parallel in one direction. Specifically, the Halbach array includes a first block, a second block arranged to overlap the first block in one direction, and a third block located to face the first block with the second block arranged therebetween. At this time, a surface, facing the third block, of the first block is magnetized with a polarity opposite to that of a surface, facing the first block, of the third block.

Therefore, an arc generated inside an arc chamber can be guided to corners of a magnetic frame, for example, corners of the arc chamber. Accordingly, the total length of an arc path can further increase. This can result in effectively extinguishing and discharging the generated arc.

The Halbach array includes a first Halbach array arranged adjacent to one surface of a magnetic frame and a second Halbach array arranged adjacent to another surface of the magnetic frame and facing the first Halbach array with a fixed contact and a movable contact arranged therebetween. At this time, the first Halbach array and the second Halbach array produce magnetic fields in a direction away from the fixed contact and the movable contact.

Therefore, a generated arc can be extinguished while moving away from the fixed contact and the movable contact. This can suppress damage to various components, which are arranged adjacent to a center region for the operation of the DC relay, including the fixed contact and the movable contact.

The magnetic frame may include spacers each arranged between two adjacent blocks of the Halbach array to physically isolate the two blocks. At this time, a gap between the two blocks may be adjusted by the spacer.

This can result in more precisely adjusting the direction and intensity of magnetic fields produced by the Halbach array.

The effects obtained by the disclosure are not limited to the effects mentioned above, and other effects not mentioned can be clearly understood by those skilled in the art to which the disclosure pertains from the following description.

### BRIEF DESCRIPTION OF THE DRAWINGS

FIG. 1 is a perspective view of a DC relay according to an embodiment of the disclosure.

FIG. 2 is a front cross-sectional view of the DC relay of FIG. 1.

FIG. 3 is a perspective view of a fixed contact, a movable contact, and an arc path formation unit included in the DC relay of FIG. 1.

FIG. 4 is a perspective view of the arc path formation unit included in the DC relay of FIG. 1.

FIGS. 5 and 6 are plan views of the arc path formation unit of FIG. 4.

FIG. 7 is an exploded perspective view of the arc path formation unit of FIG. 4.

FIG. 8 is a planar cross-sectional view of a first magnetic frame included in the arc path formation unit of FIG. 4.

FIG. 9 is a conceptual view of magnetic fields produced by an arc path formation unit, and paths of arcs, according to an embodiment.

FIG. 10 is a conceptual view of magnetic fields produced by an arc path formation unit, and paths of arcs, according to another embodiment.

### DETAILED DESCRIPTION

Hereinafter, an arc formation unit 100 and a direct current (DC) relay according to an embodiment of the disclosure will be described in more detail with reference to the accompanying drawings.

In the following description, descriptions of some components will be omitted to clarify features of the disclosure.

In this specification, the same/like reference numerals are given to the same/like components even in different embodiments, and a redundant description thereof will be omitted.

The accompanying drawings are merely used to help easily understand the technical idea of the disclosure and it should be understood that the idea of the disclosure is not limited by the accompanying drawings.

### 1. Definition of Terms

The singular form is intended to include the plural form as well, unless the context clearly indicates otherwise.

The term “magnetize” used in the following description refers to a phenomenon in which an object exhibits magnetism in a magnetic field.

The term “polarities” used in the following description refers to different properties belonging to an anode and a cathode of an electrode. In one implementation, the polarities may be classified into an N pole or an S pole.

The term “electric connection” used in the following description means a state in which two or more members are electrically connected.

The term “arc path” used in the following description refers to a path through which a generated arc moves or moves while being extinguished.

The term “Halbach array” as used in the following description refers to an assembly of a plurality of magnetic bodies which are arranged in parallel to form rows or columns.

The plurality of magnetic bodies constituting the Halbach array may be arranged according to certain rules. The plurality of magnetic bodies may produce magnetic fields by themselves or with each other.

The Halbach array includes two relatively long surfaces and two relatively short surfaces. Magnetic fields which are produced by the magnetic bodies constituting the Halbach array on the outer side of one of the two long surfaces may be stronger.

In the following description, it is assumed that a magnetic field produced toward the center of the arc path formation unit 100 is stronger among the magnetic fields produced by the Halbach array.

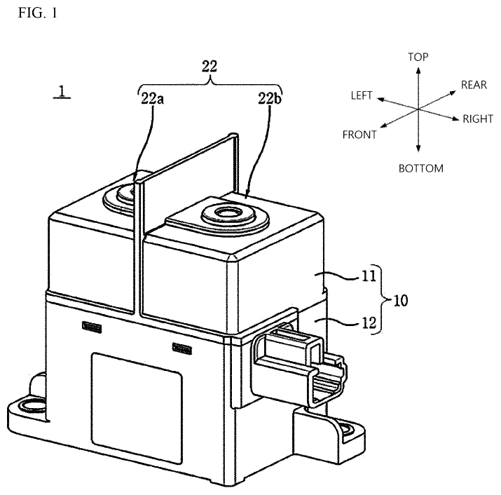

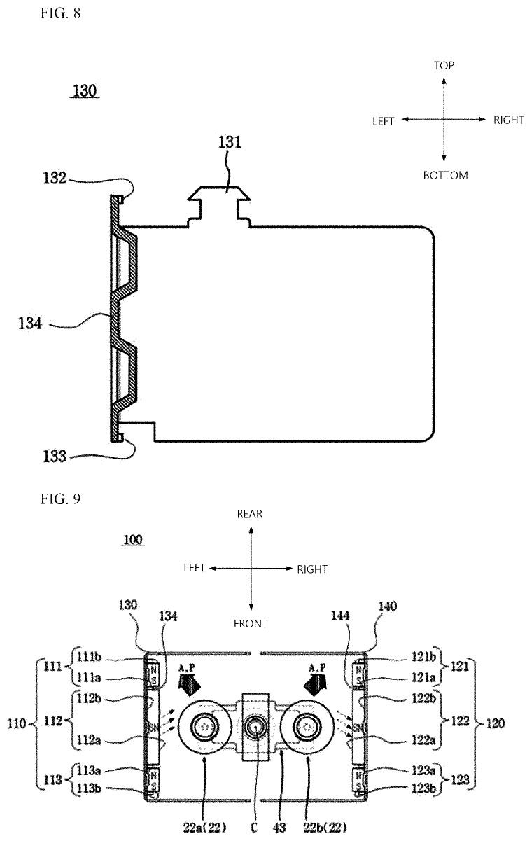

The terms “top,” “bottom,” “left,” “right,” “front,” and “rear” used in the following description will be understood based on a coordinate system illustrated in FIGS. 1 to 3 and 5 to 8.

### 2. Description of Configuration of DC Relay 1 According to Embodiment

Hereinafter, a DC relay 1 according to an embodiment of the disclosure will be described with reference to FIGS. 1 to 3.

In the shown embodiment, the DC relay 1 includes a frame unit 10, an opening and closing unit 20, a core unit 30, a movable contact unit 40, and an arc path formation unit 100.

Hereinafter, each configuration of the DC relay 1 according to the embodiment will be described with reference to the accompanying drawings, and the arc path formation unit 100 will be described in a separate clause.

### (1) Description of Frame Unit 10

The frame unit 10 defines appearance of the DC relay 1. A certain space is defined inside the frame unit 10. Various devices for the DC relay 1 to perform functions for applying or cutting off current transmitted from outside may be accommodated in the space. For example, the frame unit 10 functions as a kind of housing.

The frame unit 10 may be formed of an insulating material, such as synthetic resin. This suppresses an arbitrary electrical connection between inside and outside of the frame unit 10.

In the shown embodiment, the frame unit 10 includes an upper frame 11, a lower frame 12, an insulating plate 13, and a supporting plate 14.

The upper frame 11 defines an upper side of the frame unit 10. A certain space is defined inside the upper frame 11.

The opening and closing unit 20 and the movable contact unit 40 may be accommodated in the inner space of the upper frame 11. The arc path formation unit 100 may also be accommodated in the inner space of the upper frame 11.

The upper frame 11 may be coupled to the lower frame 12. The insulating plate 13 and the supporting plate 14 may be arranged in a space between the upper frame 11 and the lower frame 12.

A fixed contact (a stationary contact or a stationary contactor) 22 of the opening and closing unit 20 is located on one side of the upper frame 11, for example, on an upper side of the upper frame 110 in the shown embodiment. The fixed contact 22 may be partially exposed to the upper side of the upper frame 11, to be electrically connected to an external power source or a load. To this end, a through hole through which the fixed contact 22 is coupled may be formed at the upper side of the upper frame 11.

The lower frame 12 defines a lower side of the frame unit 10. A certain space is defined inside the lower frame 12. The core unit 30 may be accommodated in the inner space of the lower frame 12.

The lower frame 12 may be coupled to the upper frame 11. The insulating plate 13 and the supporting plate 14 may be arranged in a space between the lower frame 12 and the upper frame 11.

The insulating plate 13 and the supporting plate 14 electrically and physically isolate the inner space of the upper frame 11 and the inner space of the lower frame 12 from each other.

The insulating plate 13 is located between the upper frame 11 and the lower frame 12. The insulating plate 13 allows the upper frame 11 and the lower frame 12 to be electrically spaced apart from each other. To this end, the insulating plate 13 may be formed of an insulating material, such as synthetic resin.

The insulating plate 13 may suppress arbitrary electrical connection between the opening and closing unit 20, the movable contact unit 40, and the arc path formation unit 100, which are accommodated in the upper frame 11, and the core unit 30 accommodated in the lower frame 12.

A through hole (not shown) is formed through a central portion of the insulating plate 13. A shaft 44 of the movable contact unit 40 is coupled through the through hole (not shown) to be movable up and down.

The supporting plate 14 is located below the insulating plate 13. The insulating plate 13 may be supported by the supporting plate 14.

The supporting plate 14 is located between the upper frame 11 and the lower frame 12.

The supporting plate 14 allows the upper frame 11 and the lower frame 12 to be electrically spaced apart from each other. The supporting plate 14 supports the insulating plate 13.

The supporting plate 14 may be formed of a magnetic material. Therefore, the supporting plate 14 may configure a magnetic circuit together with a yoke 33 of the core unit 30. The magnetic circuit may apply driving force to a movable core 32 of the core unit 30 such that the movable core 32 moves toward a fixed core 31.

A through hole (not shown) is formed through a central portion of the supporting plate 14. The shaft 44 is coupled through the through hole (not shown) to be movable up and down. Therefore, when the movable core 32 moves toward or away from the fixed core 31, the shaft 44 and a movable contact 43 connected to the shaft 44 may also move in the same direction.

### (2) Description of Opening and Closing Unit 20

The opening and closing unit 20 allows current to be applied to or cut off according to an operation of the core unit 30. Specifically, the opening and closing unit 20 may allow or block an application of current as the fixed contact 22 and the movable contact 43 are brought into contact with or separated from each other.

The opening and closing unit 20 is accommodated in the inner space of the upper frame 11. The opening and closing unit 20 may be electrically and physically spaced apart from the core unit 30 by the insulating plate 13 and the supporting plate 14.

In the shown embodiment, the opening and closing unit 20 includes an arc chamber 21, a fixed contact 22, and a sealing member 23.

The arc path formation unit 100 may be arranged outside the arc chamber 21. The arc path formation unit 100 may generate a magnetic field for forming a movement path of arcs generated inside the arc chamber 21. A detailed description thereof will be given later.

The arc chamber 21 extinguishes an arc at an inner space, when the arc is generated as the fixed contact 22 and the movable contact 43 are separated from each other. Therefore, the arc chamber 21 may also be referred to as an “arc extinguishing portion.”

The arc chamber 21 hermetically accommodates the fixed contact 22 and the movable contact 43. For example, the fixed contact 22 and the movable contact 43 are accommodated in the arc chamber 21. Accordingly, the arc generated when the fixed contact 22 and the movable contact 43 are separated from each other does not arbitrarily leak to the outside of the arc chamber 210.

The arc chamber 21 may be filled with extinguishing gas. The extinguishing gas may extinguish the generated arc and may be discharged to the outside of the DC relay 1 through a preset path. To this end, a communication hole (not shown) may be formed through a wall surrounding the inner space of the arc chamber 21.

The arc chamber 21 may be formed of an insulating material. In addition, the arc chamber 21 may be formed of a material having high pressure resistance and high heat resistance. This is because the generated arc is a flow of electrons of high-temperature and high-pressure. In an embodiment, the arc chamber 21 may be formed of a ceramic material.

A plurality of through holes may be formed through an upper side of the arc chamber 21. The fixed contact 22 is coupled through each of the through holes.

In the shown embodiment, the fixed contact 22 is arranged as two contacts including a first fixed contact 22a and a second fixed contact 22b. Accordingly, the through hole formed through the upper side of the arc chamber 21 may also be arranged as two through holes.

When the fixed contact 22 is inserted through the through holes, the through holes are sealed. That is, the fixed contact 22 is hermetically coupled to the through holes. Accordingly, the generated arc cannot be discharged to the outside through the through hole.

A lower side of the arc chamber 21 may be open. The insulating plate 13 and the sealing member 23 are in contact with the lower side of the arc chamber 21. That is, the lower side of the arc chamber 21 is sealed by the insulating plate 13 and the sealing member 23. Accordingly, the arc chamber 21 can be electrically and physically isolated from an outer space of the upper frame 11.

The arc extinguished in the arc chamber 21 allows or releases an electrical connection between inside and outside of the DC relay 1 through a preset path. In an embodiment, the extinguished arc may be discharged to the outside of the arc chamber 21 through the communication hole (not shown).

The fixed contact 22 is brought into contact with or separated from the movable contact 43, so as to electrically connect or disconnect the inside and the outside of the DC relay 1.

For example, when the fixed contact 22 is brought into contact with the movable contact 43, the inside and the outside of the DC relay 1 may be electrically connected. On the other hand, when the fixed contact 22 is separated from the movable contact 43, the electrical connection between the inside and the outside of the DC relay 1 is released.

As the name implies, the fixed contact 22 does not move. That is, the fixed contact 22 is fixedly coupled to the upper frame 11 and the arc chamber 21. Accordingly, the contact and separation between the fixed contact 22 and the movable contact 43 are implemented by the movement of the movable contact 43.

One end portion of the fixed contact 22, for example, an upper end portion in the shown embodiment, is exposed to the outside of the upper frame 11. A power supply or a load may be electrically connected to the one end portion.

The fixed contact 22 may be arranged as a plurality of fixed contacts. In the shown embodiment, the fixed contact 22 is arranged as two fixed contacts, including a first fixed contact 22a on a left side and a second fixed contact 22b on a right side.

The first fixed contact 22a is located to be biased to one side from a center of the movable contact 43 in a longitudinal direction, namely, to the left in the shown embodiment. The second fixed contact 22b is located to be biased to another side from the center of the movable contact 43 in the longitudinal direction, namely, to the right in the shown embodiment.

A power source may be electrically connected to any one of the first fixed contact 22a and the second fixed contact 22b. A load may be electrically connected to another one of the first fixed contact 22a and the second fixed contact 22b.

The DC relay 1 according to the embodiment may form an arc path, regardless of a direction of the power source or load connected to the fixed contact 22. This can be achieved by the arc path formation unit 100, and a detailed description thereof will be given later.

Another end portion of the fixed contact 22, for example, a lower end portion in the shown embodiment extends toward the movable contact 43.

When the movable contact 43 moves toward the fixed contact 22, namely, upward in the shown embodiment, the lower end portion of the fixed contact 220 is brought into contact with the movable contact 43. Accordingly, the outside and the inside of the DC relay 1 can be electrically connected.

The lower end portion of the fixed contact 22 is located inside the arc chamber 21.

When control power is cut off, the movable contact 43 is separated from the fixed contact 22 by an elastic force of a return spring 36. At this time, as the fixed contact 22 and the movable contact 43 are separated from each other, an arc is generated between the fixed contact 22 and the movable contact 43. The generated arc may be extinguished by extinguishing gas inside the arc chamber 21, and may be discharged to the outside along a path formed by the arc path formation unit 100.

The sealing member 23 blocks arbitrary communication between the arc chamber 21 and the inner space of the upper frame 11. The sealing member 23 seals the lower side of the arc chamber 21 together with the insulating plate 13 and the supporting plate 14.

For example, an upper side of the sealing member 23 is coupled to the lower side of the arc chamber 21. A radial inner side of the sealing member 23 is coupled to an outer circumference of the insulating plate 13, and a lower side of the sealing member 23 is coupled to the supporting plate 14.

Accordingly, the arc generated in the arc chamber 21 and the arc extinguished by the extinguishing gas do not arbitrarily flow into the inner space of the upper frame 11.

The sealing member 23 may suppress an inner space of a cylinder 37 from arbitrarily communicating with the inner space of the frame unit 10.

### (3) Description of Core Unit 30

The core unit 30 allows the movable contact unit 40 to move upward as control power is applied. When the control power is not applied any more, the core unit 30 allows the movable contact unit 40 to move downward again.

As described above, the core unit 30 may be electrically connected to an external control power source (not shown) to receive control power.

The core unit 30 is located below the opening and closing unit 20. The core unit 30 is accommodated in the lower frame 12. The core unit 30 and the opening and closing unit 20 may be electrically and physically spaced apart from each other by the insulating plate 13 and the supporting plate 14.

The movable contact unit 40 is located between the core unit 30 and the opening and closing unit 20. The movable contact unit 40 may be moved by driving force applied by the core unit 30. Accordingly, the movable contact 43 and the fixed contact 22 can be brought into contact with each other so that the DC relay 1 can be electrically connected.

The core unit 30 includes a fixed core 31, a movable core 32, a yoke 33, a bobbin 34, coils 35, a return spring 36, and a cylinder 37.

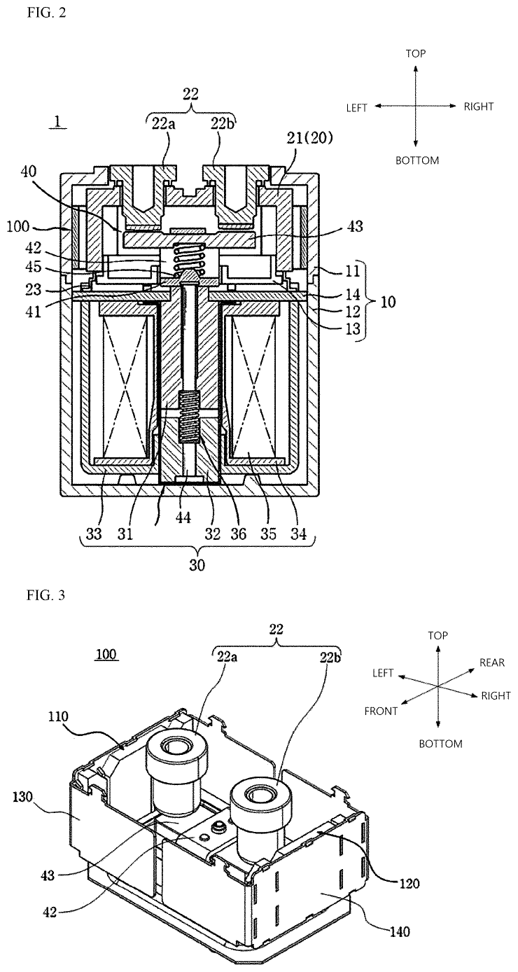

The fixed core 31 is magnetized by a magnetic field generated in the coils 35 so as to generate an electromagnetic attractive force. The movable core 32 is moved toward the fixed core 31 (upward in FIG. 2) by the electromagnetic attractive force.

The fixed core 31 does not move. That is, the fixed core 31 is fixedly coupled to the supporting plate 14 and the cylinder 37.

The movable core 31 may have any shape capable of being magnetized by the magnetic field so as to generate electromagnetic force. In an embodiment, the fixed core 31 may be implemented as a permanent magnet or an electromagnet.

The fixed core 31 is partially accommodated in an upper space inside the cylinder 37. An outer circumference of the fixed core 31 comes in contact with an inner circumference of the cylinder 37.

The fixed core 31 is located between the supporting plate 14 and the movable core 32.

A through hole (not shown) is formed through a central portion of the fixed core 31. The shaft 44 is coupled through the through hole to be movable up and down.

The fixed core 31 is spaced apart from the movable core 32 by a certain distance. Accordingly, a distance by which the movable core 32 can move toward the fixed core 31 may be limited to the certain distance. Thus, the certain distance may be defined as a “moving distance of the movable core 32.”

One end portion of the return spring 36, for example, an upper end portion in the shown embodiment is brought into contact with the lower side of the fixed core 31. When the movable core 32 moves upward as the fixed core 31 is magnetized, the return spring 36 is compressed and stores restoring force.

Accordingly, when application of control power is released and the magnetization of the fixed core 31 is terminated, the movable core 32 may be returned to the lower side by the restoring force.

When control power is applied, the movable core 32 moves toward the fixed core 31 by the electromagnetic attractive force generated by the fixed core 31.

As the movable core 32 moves, the shaft 44 coupled to the movable core 32 moves toward the fixed core 31, namely, upward in the shown embodiment. As the shaft 44 moves, the movable contact unit 40 coupled to the shaft 44 also moves upward. Accordingly, the fixed contact 22 and the movable contact 43 may be brought into contact with each other so that the DC relay 1 can be electrically connected to the external power source and the load.

The movable core 32 may have any shape capable of receiving an attractive force by the electromagnetic force. In an embodiment, the movable core 32 may be formed of a magnetic material or implemented as a permanent magnet or an electromagnet.

The movable core 32 is accommodated inside the cylinder 37. The movable core 32 may move inside the cylinder 37 in the longitudinal direction of the cylinder 37, for example, in the vertical direction in the shown embodiment. For example, the movable core 32 may move toward the fixed core 31 and away from the fixed core 31.

The movable core 32 is coupled to the shaft 44. The movable core 32 may move integrally with the shaft 44. When the movable core 32 moves upward or downward, the shaft 44 also moves upward or downward. Accordingly, the movable contact 43 also moves upward or downward.

The movable core 32 is located below the fixed core 31. The movable core 32 is spaced apart from the fixed core 31 by a certain distance. As described above, the certain distance may be defined as the moving distance of the movable core 32 in the vertical (up/down) direction.

The movable core 32 extends in the longitudinal direction. A hollow portion extending in the longitudinal direction is recessed into the movable core 32 by a certain distance. The return spring 36 and a lower side of the shaft 44 coupled through the return spring 36 are partially accommodated in the hollow portion.

A through hole is formed through a lower side of the hollow portion in the longitudinal direction. The hollow portion and the through hole communicate with each other. A lower end portion of the shaft 44 inserted into the hollow portion may proceed (be inserted) toward the through hole.

A space portion is recessed into a lower end portion of the movable core 32 by a certain distance. The space portion communicates with the through hole. A lower head portion of the shaft 44 is located in the space portion.

The yoke 33 forms a magnetic circuit as control power is applied. The magnetic circuit formed by the yoke 33 may control a direction of electromagnetic field generated by the coils 35.

Accordingly, when control power is applied, the coils 35 may generate a magnetic field in a direction in which the movable core 32 moves toward the fixed core 31. The yoke 33 may be formed of a conductive material capable of allowing electrical connection.

The yoke 33 is accommodated inside the lower frame 12. The yoke 33 surrounds the coils 35. The coils 35 may be accommodated in the yoke 33 with being spaced apart from an inner circumferential surface of the yoke 33 by a certain distance.

The bobbin 34 is accommodated inside the yoke 33. For example, the yoke 33, the coils 35, and the bobbin 34, on which the coils 35 are wound, are sequentially arranged in a direction from an outer circumference of the lower frame 12 to a radial inner side.

An upper side of the yoke 33 comes in contact with the supporting plate 14. The outer circumference of the yoke 33 may come in contact with an inner circumference of the lower frame 12 or may be located to be spaced apart from the inner circumference of the lower frame 12 by a certain distance.

The coils 35 are wound around the bobbin 34. The bobbin 34 is accommodated inside the yoke 33.

The bobbin 34 may include upper and lower portions formed in a flat shape, and a cylindrical pole portion extending in the longitudinal direction to connect the upper and lower portions. That is, the bobbin 34 has a bobbin shape.

The upper portion of the bobbin 34 comes in contact with the lower side of the supporting plate 14. The coils 35 are wound around the pole portion of the bobbin 34. A wound thickness of the coils 35 may be equal to or smaller than a diameter of the upper and lower portions of the bobbin 34.

A hollow portion is formed through the pole portion of the bobbin 34 extending in the longitudinal direction. The cylinder 37 may be accommodated in the hollow portion. The pole portion of the bobbin 34 may be arranged to have the same central axis as the fixed core 31, the movable core 32, and the shaft 44.

The coils 35 generate magnetic fields as control power is applied. The fixed core 31 may be magnetized by the electric field generated by the coils 35 and thus an electromagnetic attractive force may be applied to the movable core 32.

The coils 35 are wound around the bobbin 34. For example, the coils 35 are wound around the pole portion of the bobbin 34 and stacked on a radial outside of the pole portion. The coils 35 are accommodated inside the yoke 33.

When control power is applied, the coils 35 generate magnetic fields. In this case, intensity or direction of the magnetic fields generated by the coils 35 may be controlled by the yoke 33. The fixed core 31 is magnetized by the magnetic fields generated by the coils 35.

When the fixed core 31 is magnetized, the movable core 32 receives an electromagnetic force, namely, an attractive force in a direction toward the fixed core 31. Accordingly, the movable core 32 moves toward the fixed core 31, for example, upward in the shown embodiment.

The return spring 36 applies restoring force to return the movable core 32 to its original position when control power is not applied any more after the movable core 32 moves toward the fixed core 31.

The return spring 36 stores restoring force while being compressed as the movable core 32 moves toward the fixed core 31. At this time, the stored restoring force is preferably smaller than the electromagnetic attractive force, which is exerted on the movable core 32 as the fixed core 31 is magnetized. This can suppress the movable core 32 from being returned to its original position by the return spring 36 while control power is applied.

When control power is not applied any more, only the restoring force by the return spring 36 is exerted on the movable core 32. Of course, gravity due to an empty weight of the movable core 32 may also be applied to the movable core 32. Accordingly, the movable core 32 can move away from the fixed core 31 to be returned to the original position.

The return spring 36 may be formed in any shape which is deformed to store the restoring force and returned to its original state to transfer the restoring force to the outside. In an embodiment, the return spring 36 may be configured as a coil spring.

The shaft 44 is coupled through the return spring 36. The shaft 44 may move up and down regardless of the deformation of the return spring 36 in the coupled state with the return spring 36.

The return spring 36 is accommodated in the hollow portion recessed in the upper side of the movable core 32. One end portion of the return spring 36 facing the fixed core 31, for example, an upper end portion in the shown embodiment, is accommodated in a hollow portion recessed into a lower side of the fixed core 31.

The cylinder 37 accommodates the fixed core 31, the movable core 32, the return spring 36, and the shaft 44. The movable core 32 and the shaft 44 may move up and down in the cylinder 37.

The cylinder 37 is located in the hollow portion formed through the pole portion of the bobbin 34. An upper end portion of the cylinder 37 is brought into contact with a lower surface of the supporting plate 14.

A side surface of the cylinder 37 comes in contact with an inner circumferential surface of the pole portion of the bobbin 34. An upper opening of the cylinder 37 may be closed by the fixed core 31. A lower surface of the cylinder 37 may come in contact with an inner surface of the lower frame 12.

### (4) Description of Movable Contact Unit 40

The movable contact unit 40 includes the movable contact 43 and components for moving the movable contact 43. The movable contact unit 40 may allow the DC relay 1 to be electrically connected to an external power source and a load.

The movable contact unit 40 is accommodated in the inner space of the upper frame 11. The movable contact unit 40 is accommodated in the arc chamber 21 to be movable up and down.

The fixed contact 22 is located above the movable contact unit 40. The movable contact unit 40 is accommodated in the arc chamber 21 to be movable in a direction toward the fixed contact 22 and a direction away from the fixed contact 22.

The core unit 30 is located below the movable contact unit 40. The movement of the movable contact unit 40 may be achieved by the movement of the movable core 32.

The movable contact unit 40 includes a housing 41, a cover 42, a movable contact 43, a shaft 44, and an elastic portion 45.

The housing 41 accommodates the movable contact 43 and the elastic portion 45 elastically supporting the movable contact 43.

In the shown embodiment, the housing 41 is formed such that one side and another side opposite to the one side are open. The movable contact 43 may be inserted through the openings.

A side surface of the housing 41 which is not open may surround the accommodated movable contact 43.

The cover 42 is arranged on an upper side of the housing 41. The cover 42 covers an upper surface of the movable contact 43 accommodated in the housing 41.

The housing 41 and the cover 42 are preferably formed of an insulating material to suppress unexpected electrical connection. In an embodiment, the housing 41 and the cover 42 may be formed of a synthetic resin or the like.

A lower side of the housing 41 is connected to the shaft 44. When the movable core 32 connected to the shaft 44 moves upward or downward, the housing 41 and the movable contact 43 accommodated in the housing 410 may also move upward or downward.

The housing 41 and the cover 42 may be coupled by arbitrary members. In an embodiment, the housing 41 and the cover 42 may be coupled by fastening members (not shown), such as bolts and nuts.

When control power is applied, the movable contact 43 is brought into contact with the fixed contact 22, such that the DC relay 1 can be electrically connected to an external power source and a load. When control power is not applied any more, the movable contact 43 is separated from the fixed contact 22, such that the DC relay 1 can be electrically disconnected from the external power source and the load.

The movable contact 43 is located adjacent to the fixed contact 22.

An upper side of the movable contact 43 is covered by the cover 42. In an embodiment, a portion of the upper surface of the movable contact 43 may be in contact with a lower surface of the cover 42.

A lower side of the movable contact 43 is elastically supported by the elastic portion 45. To suppress the movable contact 43 from being arbitrarily moved downward, the elastic portion 45 may elastically support the movable contact 43 in a compressed state by a certain distance.

The movable contact 43 extends in the longitudinal direction, for example, in left and right directions in the shown embodiment. For example, a length of the movable contact 43 is larger than its width. Accordingly, both end portions of the movable contact 43 in the longitudinal direction, accommodated in the housing 41, are exposed to the outside of the housing 41.

Contact protrusions may protrude upward from the both end portions by predetermined distances. The fixed contact 22 is brought into contact with the contact protrusions.

Each of the contact protrusions may be formed at a position corresponding to the fixed contact 22. Accordingly, the moving distance of the movable contact 43 can be reduced and contact reliability between the fixed contact 22 and the movable contact 43 can be improved.

The width of the movable contact 43 may be the same as a spaced distance between the side surfaces of the housing 41. For example, when the movable contact 43 is accommodated in the housing 41, both side surfaces of the movable contact 43 in a widthwise direction may be brought into contact with inner surfaces of the side surfaces of the housing 41.

Accordingly, the state where the movable contact 43 is accommodated in the housing 41 can be stably maintained.

The shaft 44 transmits driving force, which is generated in response to the operation of the core unit 30, to the movable contact unit 40. For example, the shaft 44 is connected to the movable core 32 and the movable contact 43. When the movable core 32 moves upward or downward, the movable contact 43 may also move upward or downward by the shaft 44.

The shaft 44 extends in the longitudinal direction, namely, in the up and down (vertical) direction in the shown embodiment.

The lower end portion of the shaft 44 is inserted into the movable core 32. When the movable core 32 moves up and down, the shaft 44 may also move up and down together with the movable core 32.

A body portion of the shaft 44 is coupled through the fixed core 31 to be movable up and down. The return spring 36 is coupled through the body portion of the shaft 44.

An upper end portion of the shaft 44 is coupled to the housing 41. When the movable core 32 moves, the shaft 44 and the housing 41 may also move.

The upper and lower end portions of the shaft 44 may have a larger diameter than the body portion of the shaft 44. Accordingly, the coupled state of the shaft 44 to the housing 41 and the movable core 32 can be stably maintained.

The elastic portion 45 elastically supports the movable contact 43. When the movable contact 43 is brought into contact with the fixed contact 22, the movable contact 43 tends to be separated from the fixed contact 22 due to electromagnetic repulsive force. At this time, the elastic portion 45 elastically supports the movable contact 43 to suppress the movable contact 43 from being arbitrarily separated from the fixed contact 22.

The elastic portion 45 may have an arbitrary shape which is capable of storing restoring force due to shape deformation and applying the stored restoring force to another member. In an embodiment, the elastic portion 45 may be configured as a coil spring.

One end portion of the elastic portion 45 facing the movable contact 43 comes in contact with the lower side of the movable contact 43. Another end portion opposite to the one end portion comes in contact with the upper side of the housing 41.

The elastic portion 45 may elastically support the movable contact 43 in a state of storing the restoring force by being compressed by a certain length. Accordingly, even if electromagnetic repulsive force is generated between the movable contact 43 and the fixed contact 22, the movable contact 43 does not arbitrarily move.

A protrusion (not shown) which is inserted into the elastic portion 45 may protrude from the lower side of the movable contact 43 to enable stable coupling of the elastic portion 45. Likewise, a protrusion (not shown) which is inserted into the elastic portion 45 may protrude from the upper side of the housing 41.

### 3. Description of Arc Path Formation Unit 100 According to Embodiment

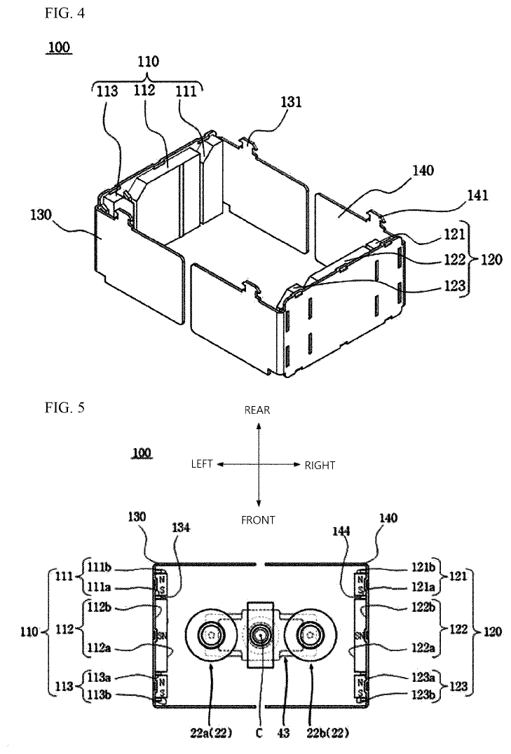

Referring to FIGS. 3 to 8, an arc path formation unit 100 according to an embodiment of the disclosure is illustrated. Hereinafter, an arc path formation unit 100 according to an embodiment will be described with reference to FIGS. 3 to 8.

The arc path formation unit 100 to be described below is described on the assumption that the arc path formation unit 100 is included in a DC relay 1. However, it will be understood that the arc path formation unit 100 may be applied to a device, such as a magnetic contactor, a magnetic switch, or the like, which can be connected to and disconnected from the outside by contact and separation between fixed and movable contacts.

The arc path formation unit 100 produces magnetic fields inside the arc chamber 21. An electromagnetic force is generated inside the arc chamber 21 by a current flowing in the DC relay 1 and the produced magnetic fields.

An arc which is generated as the fixed contact 22 and the movable contact 43 are separated from each other moves to the outside of the arc chamber 21 by the generated electromagnetic force. For example, the generated arc moves separately in a direction in which the electromagnetic force is generated. Accordingly, it may be said that the arc path formation unit 100 forms an arc path as a path along which the generated arc flows.

The arc path formation unit 100 is located in the inner space of the upper frame 11. The arc path formation unit 100 surrounds the arc chamber 21. In other words, the arc chamber 21 is located inside the arc path formation unit 100.

The fixed contact 22 and the movable contact 43 are located inside the arc path formation unit 100. The arc generated by the separation of the movable contact 43 from the fixed contact 22 may be induced by the electromagnetic force generated by the arc path formation unit 100.

In the shown embodiment, the arc path formation unit 100 includes a first Halbach array 110, a second Halbach array 120, a first magnetic frame 130, and a second magnetic frame 140.

The first Halbach array 110 and the second Halbach array 120 together produce magnetic fields inside the arc path formation unit 100 in which the fixed contact 22 and the movable contact 43 are accommodated. At this time, the first Halbach array 110 and the second Halbach array 120 may produce magnetic fields by themselves or with each other.

The first Halbach array 110 is arranged adjacent to a left inner circumferential surface of the first magnetic frame 130, and the second Halbach array 120 is arranged adjacent to a right inner circumferential surface of the second magnetic frame 140.

The first Halbach array 110 and the second Halbach array 120 are arranged to face each other with the fixed contact 22 and the movable contact 43 arranged therebetween.

The first Halbach array 110 and the second Halbach array 120 produce an electromagnetic force together with the current flowing through the fixed contact 22 and the movable contact 43. The produced electromagnetic force induces an arc which is generated when the fixed contact 22 and the movable contact 43 are separated from each other.

At this time, the arc path formation unit 100 forms an electromagnetic force in a direction away from a center region C thereof. Accordingly, the path of the arc is also formed in the direction away from the center region C.

As a result, each component included in the DC relay 1 is not damaged by the generated arc. Further, the generated arc may be rapidly discharged to the outside of the arc chamber 21.

The first Halbach array 110 and the second Halbach array 120 may strengthen the intensity of the magnetic fields which are produced by themselves and with each other. The direction of the magnetic fields produced by the Halbach arrays and the process of strengthening the magnetic fields are well known technologies, so a detailed description thereof will be omitted.

In the shown embodiment, the first Halbach array 110 and the second Halbach array 120 each include a plurality of magnetic bodies arranged in a parallel and continuous manner from the front side to the rear side. For example, the first Halbach array 110 and the second Halbach array 120 each extend in the forward and backward directions.

In the embodiment, each of the first Halbach array 110 and the second Halbach array 120 includes a first block 111, 121, a second block 112, 122, and a third block 113, 123. It will be understood that the plurality of magnetic bodies constituting each of the first Halbach array 110 and the second Halbach array 120 are named as blocks 111, 112, 133, 121, 122, and 123.

The first to third blocks 111, 112, 113, 121, 122, and 123 may each be formed of a magnetic material. In an embodiment, the first to third blocks 111, 112, 113, 121, 122, and 123 may be permanent magnets or electromagnets.

The first to third blocks 111, 112, 113, 121, 122, and 123 may be arranged in parallel in one direction. In the shown embodiment, the first to third blocks 111, 112, 113, 121, 122, and 123 are arranged in parallel in the forward and backward directions.

In the embodiment, among the first to third blocks 111, 112, 113, 121, 122, and 123, the first block 111, 121 is arranged at the rearmost side, and the third block 113, 123 is arranged at the frontmost side. The second block 112, 122 is located between the first block 111, 121 and the third block 113, 123.

In an embodiment, the second block 112, 122 may be arranged to overlap each fixed contact 22 in the arrangement direction of the plurality of fixed contacts 22, for example, in the left and right directions in the shown embodiment.

In the shown embodiment, the first to third blocks 111, 112, 113, 121, 122, and 123 extend in the forward and backward directions. However, the shapes of the first to third blocks 111, 112, 113, 121, 122, and 123 are not limited to those in the shown embodiment and may be formed in various structures. For example, at least one of the first to third blocks 111, 112, 113, 121, 122, and 123 may extend in a direction crossing the forward and backward directions.

The first to third blocks 111, 112, 113, 121, 122, and 123 each include a plurality of surfaces. The plurality of surfaces of each block 111, 112, 113, 121, 122, and 123 may be magnetized according to a certain rule to form the Halbach arrays.

In the shown embodiment, the first to third blocks 111, 112, and 113 of the first Halbach array 110 are arranged to overlap the first to third blocks 121, 122, and 123 of the second Halbach array 120 in the left and right directions, respectively.

The first block 111, 121 includes a first inner surface 111a, 121a facing the second block 112, 122 and a first outer surface 111b, 121b opposite to the second block 112, 122.

The second block 112, 122 includes a second inner surface 112a, 122a facing the fixed contact 22 and the movable contact 43 and a second outer surface 112b, 122b opposite to the fixed contact 22 and the movable contact 43.

The third block 113, 123 includes a third inner surface 113a, 123a facing the second block 112, 122 and a third outer surface 113b, 123b opposite to the second block 112, 122.

At this time, the third inner surface 113a, 123a of the third block 113, 123 is magnetized with a polarity opposite to that of the first inner surface 111a, 121a of the first block 111, 121.

The first inner surface 111a of the first block 111 included in the first Halbach array 110 is magnetized with the same polarity as that of the first inner surface 121a of the first block 121 included in the second Halbach array 120.

Therefore, it can be considered that the third inner surface 113a of the third block 113 included in the first Halbach array 110 is magnetized with the same polarity as that of the third inner surface 123a of the third block 123 included in the second Halbach array 120.

Therefore, the generated arc can be guided to corners of the magnetic frames 130 and 140, for example, corners of the arc chamber 21. Therefore, the total length of the arc path A. P can more increase. This can result in effectively extinguishing and discharging the generated arc.

The magnetic fields produced by the Halbach arrays 110 and 120 are produced in the direction away from the fixed contact 22 and the movable contact 43, such that the generated arc can be extinguished while moving in the direction away from the fixed contact 22 and the movable contact 43. This can suppress damage to various components, which are arranged adjacent to the center region for the operation of the DC relay 1, including the fixed contact 22 and the movable contact 43.

In the embodiment shown in FIG. 5, the second inner surface 112b of the second block 112 included in the first Halbach array 110 is magnetized with a polarity opposite to that of the second inner surface 122b of the second block 122 included in the second Halbach array 120.

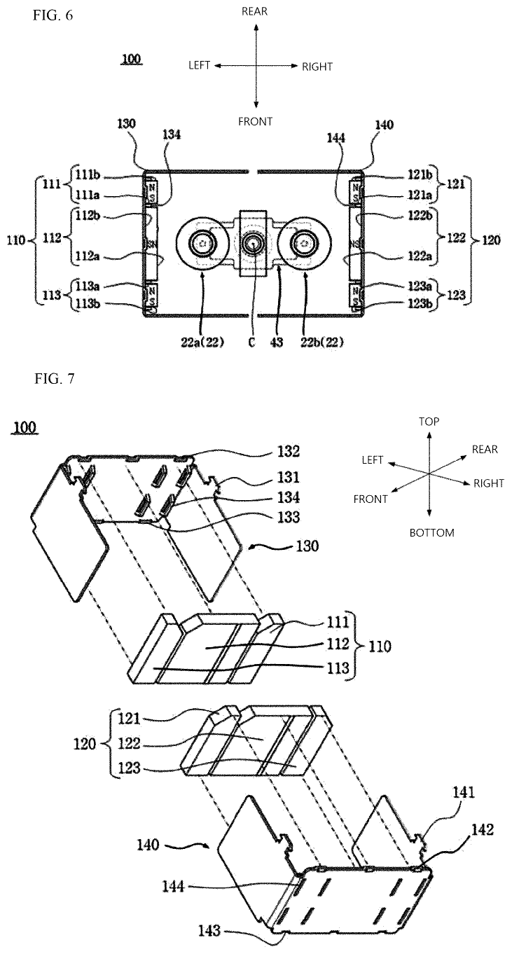

In the embodiment shown in FIG. 6, the second inner surface 112b of the second block 112 included in the first Halbach array 110 is magnetized with the same polarity as that of the second inner surface 122b of the second block 122 included in the second Halbach array 120.

The first Halbach array 110 and the second Halbach array 120 are arranged adjacent to inner circumferential surfaces of the magnetic frames 130 and 140, respectively.

The magnetic frame 130, 140 extends in the longitudinal direction, for example, in the left and right directions in the shown embodiment. The shape of the magnetic frame 130, 140 may vary depending on shapes of the upper frame 11 and the arc chamber 21.

In the shown embodiment, the magnetic frame 130, 140 is formed such that a length in the forward and backward directions, in which the corresponding Halbach array 110, 120 extends, is smaller than a length in the left and right directions.

The magnetic frame 130, 140 may be arranged as a plurality of magnetic frames, which are located to be spaced apart from each other. In the shown embodiment, the magnetic frame 130, 140 includes a first magnetic frame 130 and a second magnetic frame 140 which are each formed in a ‘⊏’ shape and are symmetrical to each other based on the center region C. For example, the first magnetic frame 130 is arranged on the left side of the center region C, and the second magnetic frame 140 is arranged on the right side.

The fixed contact 22 and the movable contact 43 are accommodated in an inner space portion surrounded by the first magnetic frame 130 and the second magnetic frame 140. The arc chamber 21 is accommodated in the space portion. In the shown embodiment, the space portion is formed such that a length in the left and right directions, in which the fixed contact 22 is arranged, is greater than a length in the forward and backward directions.

The movable contact 43 may move in the space portion in a direction toward the fixed contact 22 (downward in the shown embodiment) or a direction away from the fixed contact 22 (upward in the shown embodiment).

A path of an arc which is generated in the arc chamber 21 is formed in the space portion. This is achieved by the magnetic fields produced by the first and second Halbach arrays 110 and 120.

In an embodiment, a center portion of the space portion may coincide with the center region C of the arc path formation unit 100.

The center region C is located between the first fixed contact 22a and the second fixed contact 22b. A center portion of the movable contact unit 40 is located perpendicularly below the center region C. For example, center portions of the housing 41, the cover 42, the movable contact 43, the shaft 44, and the elastic portion 45 are located perpendicularly below the center region C.

The first Halbach array 110 is arranged adjacent to an inner circumferential surface of the first magnetic frame 130. For example, the first Halbach array 110 is coupled to one surface of the first magnetic frame 130, namely, a right surface in the shown embodiment, which opposes the fixed contact 22 and the movable contact 43.

In the shown embodiment, the first magnetic frame 130 includes a fitting portion 131, an upper end fixing portion 132, a lower end fixing portion 133, and a spacer 134.

The fitting portion 131 is a portion where the first magnetic frame 130 and the upper frame 11 are directly connected.

The fitting portion 131 is formed to protrude from one end of the first magnetic frame 130 which faces the upper frame 11, for example, an upper end in the shown embodiment, in a direction toward the upper frame 11, for example, upward in the shown embodiment.

A through hole (not shown) for inserting the fitting portion 131 may be formed through the upper frame 11. In the shown embodiment, the fitting portion 131 includes a stop portion which protrudes therefrom in the left and right directions, and may be fixed while being inserted through the through hole of the upper frame 11.

However, the fitting portion 131 is not limited to the shown embodiment, and may be formed in any shape that may be fixed while being inserted into the through hole of the upper frame 11.

In the shown embodiment, the upper end fixing portion 132 may be formed on one end of the first magnetic frame 130, for example, an upper end in the shown embodiment, to suppress an arbitrary separation of the first Halbach array 110.

The upper end fixing portion 132 is arranged to be in contact with the upper end of the first Halbach array 110. Accordingly, the upper end fixing portion 132 supports the first Halbach array 110 from the upper side and suppresses the upward movement of the first Halbach array 110.

In the shown embodiment, the upper end fixing portion 132 is arranged on an upper end of an inner circumferential surface of the first magnetic frame 130 and protrudes away from the inner circumferential surface of the first magnetic frame 130, for example, to the right in the shown embodiment.

The upper end fixing portion 132 may be arranged as a plurality of upper end fixing portions. At this time, it is preferable that the number of upper end fixing portions 132 be equal to the number of blocks included in the first Halbach array 110 and the upper end fixing portions 132 be positioned on upper sides of the respective blocks 111, 112, and 113. In the shown embodiment, three upper end fixing portions 132 are arranged on the upper sides of the corresponding first block 111, second block 112, and third block 113.

The lower end fixing portion 133 may be formed on another end of the first magnetic frame 130, for example, a lower end in the shown embodiment, to suppress an arbitrary separation of the first Halbach array 110.

The lower end fixing portion 133 is arranged to be in contact with the lower end of the first Halbach array 110. Accordingly, the lower end fixing portion 133 supports the first Halbach array 110 from the lower side and suppresses the downward movement of the first Halbach array 110.

In the shown embodiment, the lower end fixing portion 133 is arranged on a lower end of the inner circumferential surface of the first magnetic frame 130 and protrudes away from the inner circumferential surface of the first magnetic frame 130, for example, to the right in the shown embodiment.

The lower end fixing portion 133 may be arranged to oppose the upper end fixing portion 132 with the first Halbach array 110 arranged therebetween.

The lower end fixing portion 133 may be arranged as a plurality of lower end fixing portions. At this time, it is preferable that the number of lower end fixing portions 133 be equal to the number of blocks included in the first Halbach array 110 and the lower end fixing portions 133 be positioned on lower sides of the respective blocks 111, 112, and 113. In the shown embodiment, three lower end fixing portions 133 are arranged on the lower sides of the corresponding first block 111, second block 112, and third block 113.

The spacer 134 which is spaced apart from the upper end fixing portion 132 and the lower end fixing portion 133 is arranged on the inner circumferential surface of the first magnetic frame 130.

The spacer 134 is arranged between two adjacent blocks of the first Halbach array 110 such that the two blocks are spaced apart from each other.

The spacer 134 is arranged on the inner circumferential surface of the first magnetic frame 130. At this time, the spacer 134 protrudes in a direction away from the inner circumferential surface of the first magnetic frame 130, i.e., to the right in the shown embodiment.

The spacer 134 is arranged between two adjacent blocks of the first Halbach array 110. In the shown embodiment, the spacers 134 are arranged on the rear side of the first block 111, between the first block 111 and the second block 112, between the second block 112 and the third block 113, and on the front side of the third block 113.

Therefore, the two adjacent blocks can be spaced apart from each other by the spacer 134. Accordingly, the blocks 111, 112, and 113 constituting the first Halbach array 110 can maintain relative positions thereof without moving due to attractive or repulsive force acting between adjacent blocks. This can result in suppressing an arbitrary separation of the first to third blocks 111, 112, and 113. With the configuration, materials for fixing magnetic bodies, for example, adhesives can be reduced, and the overall manufacturing cost of the DC relay 1 can be reduced.

The blocks 111, 112, and 113 constituting the first Halbach array 110 may generate a rotational moment due to mutual attractive and repulsive forces. The spacer 134 supports each block 111, 112, and 113 of the first Halbach array 110 in the arrangement direction, for example, in the forward and backward directions in the shown embodiment, so as to suppress rotation due to the attractive or repulsive force between adjacent blocks 111, 112, and 113.

Accordingly, damage to the DC relay 1 due to arbitrary movement of each block 111, 112, and 113 can be suppressed. This can result in further improving the durability of the entire DC relay 1 including the arc path formation unit 100, and further extending the expected lifespan of the DC relay 1.

The spacer 134 extends along a gap between two adjacent blocks of the first Halbach array 110. In the shown embodiment, the spacer 134 extends in the vertical (up and down) direction.

In an embodiment, the spacer 134 may be integrally formed with the inner circumferential surface of the first magnetic frame 130. For example, the spacer 134 may be manufactured by a sheet metal working method which applies a force radially inward to a portion of the first magnetic frame 130.

In an embodiment, the height of the spacer 134 in the extension direction may decrease in a direction away from the inner circumferential surface of the first magnetic frame 130. In the shown embodiment, the height of the spacer 134 in the vertical direction decreases from the left surface of the first magnetic frame 130 to the right side. This is to minimize cracks occurring during the sheet metal working process and maximize a protrusion width of the spacer 134 to more stably support the first Halbach array 110.

The spacer 134 may be arranged as a plurality of spacers.

One block of the first Halbach array 110 may be arranged between two different spacers 134. For example, two different spacers 134 may be arranged to face each other with one block of the first Halbach array 110 located therebetween.

In an embodiment, a gap between the two different spacers 134 may correspond to a length of the one block in the arrangement direction of the first Halbach array 110, for example, in the forward and backward directions in the shown embodiment.

Therefore, the gap between two adjacent blocks can be adjusted by the spacer 134. For example, the assembly of the first magnetic frame 130 and the first Halbach array 110 is facilitated. At this time, the gap between the two blocks can be guided and adjusted more precisely by the thickness and position of the spacer 134.

The spacer 134 may be formed such that a thickness thereof in the arrangement direction of the first Halbach array 110, for example, in the forward and backward directions in the shown embodiment, corresponds to a gap between two adjacent blocks of the Halbach array 110, 120.

Therefore, the gap between the two adjacent blocks can be adjusted by the thickness and position of the spacer 134. This can result in more precisely adjusting the direction and intensity of magnetic fields produced by the Halbach array 110, 120.

In an embodiment, the spacer 134 may have a thickness in the range of 1 mm to 2 mm in the arrangement direction of the first Halbach array 110, for example, in the forward and backward directions in the shown embodiment.

When the thickness of the spacer 134 in the forward and backward directions is excessively large, the magnitude of a magnetic force between the blocks 111, 112, and 113 of the first Halbach array 110 may decrease, and thereby magnetic fields may not be sufficiently produced inside the arc path formation unit 100.

In another example, when the thickness of the spacer 134 in the forward and backward directions is excessively small, a repulsive force between the blocks 111, 112, and 113 of the first Halbach array 110 may increase, making it difficult for the blocks 111, 112, and 113 to be maintained at positions thereof without being randomly separated.

The spacer 134 may be arranged as a plurality of spacers along the gap between two adjacent blocks of the first Halbach array 110. In the shown embodiment, the spacers 134 are arranged in two rows in the vertical direction between the first block 111 and the second block 112 and between the second block 112 and the third block 113. This is to reduce the length of each spacer 134 in the left and right directions and improve durability of the spacer 134.

The first magnetic frame 130 is located to face the second magnetic frame 140 with the fixed contact 22, the movable contact 43, the first Halbach array 110, and the second Halbach array 120 arranged therebetween.

The second Halbach array 120 is arranged adjacent to an inner circumferential surface of the second magnetic frame 140. For example, the second Halbach array 120 is coupled to one surface of the second magnetic frame 140, namely, a left surface in the shown embodiment, which opposes the fixed contact 22 and the movable contact 43.

In the shown embodiment, the second magnetic frame 140 includes a fitting portion 141, an upper end fixing portion 142, a lower end fixing portion 143, and a spacer 144.

The fitting portion 141 is a portion where the second magnetic frame 140 and the upper frame 11 are directly connected.

The fitting portion 141 is formed to protrude from one end of the second magnetic frame 140 which faces the upper frame 11, for example, an upper end in the shown embodiment, in a direction toward the upper frame 11, for example, upward in the shown embodiment.

A through hole (not shown) for inserting the fitting portion 141 may be formed through the upper frame 11. In the shown embodiment, the fitting portion 141 includes a stop portion which protrudes therefrom in the left and right directions, and may be fixed while being inserted through the through hole of the upper frame 11.

However, the fitting portion 141 is not limited to the shown embodiment, and may be formed in any shape that may be fixed while being inserted into the through hole of the upper frame 11.

In the shown embodiment, an upper end fixing portion 142 may be formed on one end of the second magnetic frame 140, for example, an upper end in the shown embodiment, to suppress an arbitrary separation of the second Halbach array 120.

The upper end fixing portion 142 is arranged to be in contact with the upper end of the second Halbach array 120. Accordingly, the upper end fixing portion 142 supports the second Halbach array 120 from the upper side and suppress the upward movement of the second Halbach array 120.

In the shown embodiment, the upper end fixing portion 142 is arranged on an upper end of an inner circumferential surface of the second magnetic frame 140 and protrudes away from the inner circumferential surface of the second magnetic frame 140, for example, to the left in the shown embodiment.

The upper end fixing portion 142 may be arranged as a plurality of upper end fixing portions. At this time, it is preferable that the number of upper end fixing portions 142 be equal to the number of blocks included in the second Halbach array 120 and the upper end fixing portions 132 be positioned on upper sides of the respective blocks 121, 122, and 123. In the shown embodiment, three upper end fixing portions 142 are arranged on the upper sides of the corresponding first block 121, second block 122, and third block 123.

The lower end fixing portion 143 may be formed on another end of the second magnetic frame 140, for example, a lower end in the shown embodiment, to suppress an arbitrary separation of the second Halbach array 120.

The lower end fixing portion 143 is arranged to be in contact with the lower end of the second Halbach array 120. Accordingly, the lower end fixing portion 143 supports the second Halbach array 120 from the lower side and suppresses the downward movement of the second Halbach array 120.

In the shown embodiment, the lower end fixing portion 143 is arranged on a lower end of the inner circumferential surface of the second magnetic frame 140 and protrudes away from the inner circumferential surface of the second magnetic frame 140, for example, to the left in the shown embodiment.

The lower end fixing portion 143 may be arranged to oppose the upper end fixing portion 142 with the second Halbach array 120 arranged therebetween.

The lower end fixing portion 143 may be arranged as a plurality of lower end fixing portions. At this time, it is preferable that the number of lower end fixing portions 143 be equal to the number of blocks included in the second Halbach array 120 and the lower end fixing portions 143 be positioned on lower sides of the respective blocks 121, 122, and 123. In the shown embodiment, three lower end fixing portions 143 are arranged on the lower sides of the corresponding first block 121, second block 122, and third block 123.

The spacer 144 which is spaced apart from the upper end fixing portion 142 and the lower end fixing portion 143 is arranged on the inner circumferential surface of the second magnetic frame 140.

The spacer 144 is arranged between two adjacent blocks of the second Halbach array 120 such that the two blocks are spaced apart from each other.

The spacer 144 is arranged on the inner circumferential surface of the second magnetic frame 140. At this time, the spacer 144 protrudes in a direction away from the inner circumferential surface of the second magnetic frame 140, i.e., to the left in the shown embodiment.

The spacer 144 is arranged between two adjacent blocks of the second Halbach array 120. In the shown embodiment, the spacers 144 are arranged on the rear side of the first block 121, between the first block 121 and the second block 122, between the second block 122 and the third block 123, and on the front side of the third block 123.

The function and effect of the spacer 144 through the above-described structure are the same as the function and effect of the spacer 134 of the first magnetic frame 130 described above, and therefore a description thereof will be omitted.

The spacer 144 extends along a gap between two adjacent blocks of the second Halbach array 120. In the shown embodiment, the spacer 144 extends in the vertical (up and down) direction.

In an embodiment, the spacer 144 may be integrally formed with the inner circumferential surface of the second magnetic frame 140. For example, the spacer 144 may be manufactured by a sheet metal working method which applies a force radially inward to a portion of the second magnetic frame 140.

In an embodiment, the height of the spacer 144 in the extension direction may decrease in a direction away from the inner circumferential surface of the second magnetic frame 140. In the shown embodiment, the height of the spacer 144 in the vertical direction decreases from the right surface of the second magnetic frame 140 to the left side. This is to minimize cracks occurring during the sheet metal working process and maximize a protrusion width of the spacer 144 to more stably support the second Halbach array 120.

The spacer 144 may be arranged as a plurality of spacers.

One block of the second Halbach array 120 may be arranged between two different spacers 144. For example, two different spacers 144 may be arranged to face each other with one block of the second Halbach array 120 located therebetween.

In an embodiment, a gap between the two different spacers 144 may correspond to a length of the one block in the arrangement direction of the second Halbach array 120, for example, in the forward and backward directions in the shown embodiment.

The spacer 144 may be formed such that a thickness thereof in the arrangement direction of the first Halbach array 110, for example, in the forward and backward directions in the shown embodiment, corresponds to a gap between two adjacent blocks of the Halbach array 110, 120. In an embodiment, the spacer 144 may have a thickness in the range of 1 mm to 2 mm in the arrangement direction of the second Halbach array 120, for example, in the forward and backward directions in the shown embodiment.

The function and effect of the spacer 144 through the above-described structure are the same as the function and effect of the spacer 134 of the first magnetic frame 130 described above, and therefore a description thereof will be omitted.

The spacer 144 may be arranged as a plurality of spacers along the gap between two adjacent blocks of the second Halbach array 120. In the shown embodiment, the spacers 144 are arranged in two rows in the vertical direction between the first block 121 and the second block 122 and between the second block 122 and the third block 123.

### 4. Description of Arc Path A.P Formed by Arc Path Formation Unit 100 According to Embodiment

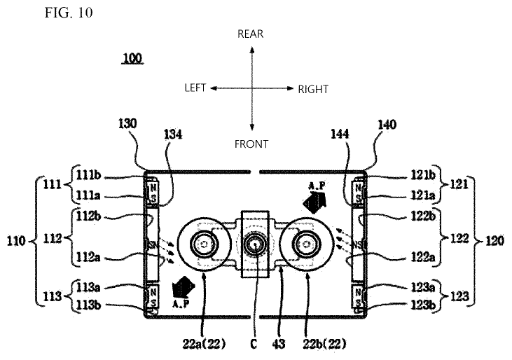

Hereinafter, an arc path A.P generated by the arc path formation unit 100 according to an embodiment will be described with reference to FIGS. 9 and 10.

As aforementioned, the first to third blocks 111, 112, and 113 of the first Halbach array 110 may be arranged to overlap the first to third blocks 121, 122, and 123 of the second Halbach array 120 in the left and right directions, respectively.

The first inner surface 111a, 121a of the first block 111, 121 is magnetized with a polarity opposite to that of the third inner surface 113a, 123a of the third block 113, 123.

Therefore, the generated arc can be guided to corners of the magnetic frames 130 and 140, for example, corners of the arc chamber 21. Therefore, the total length of the arc path A.P can further increase. This can result in effectively extinguishing and discharging the generated arc.

The magnetic fields produced by the Halbach arrays 110 and 120 are produced in the direction away from the fixed contact 22 and the movable contact 43, such that the generated arc can be extinguished while moving in the direction away from the fixed contact 22 and the movable contact 43. This can suppress damage to various components, which are arranged adjacent to the center region for the operation of the DC relay 1, including the fixed contact 22 and the movable contact 43.

In the embodiment shown in FIG. 9, the second inner surface 112b of the second block 112 included in the first Halbach array 110 is magnetized with a polarity opposite to that of the second inner surface 122b of the second block 122 included in the second Halbach array 120.

At this time, the magnetic field produced by the first Halbach array 110 is directed toward the rear right. Accordingly, the arc path A. P can be guided toward the rear left.

The magnetic field produced by the second Halbach array 120 is directed toward the front right. Accordingly, the arc path A. P can be guided toward the rear right.

In summary, the arcs generated in both the first Halbach array 110 and the second Halbach array 120 can be guided to the corners of the magnetic frames 130 and 140, for example, the corners of the arc chamber 21.

In the embodiment shown in FIG. 10, the second inner surface 112b of the second block 112 included in the first Halbach array 110 is magnetized with the same polarity as that of the second inner surface 122b of the second block 122 included in the second Halbach array 120.

At this time, the magnetic field produced by the first Halbach array 110 is directed toward the front right. Accordingly, the arc path A. P can be guided toward the front left.

The magnetic field produced by the second Halbach array 120 is directed toward the rear left. Accordingly, the arc path A.P can be guided toward the rear right.

In summary, the arcs generated in both the first Halbach array 110 and the second Halbach array 120 can be guided to the corners of the magnetic frames and 140, for example, the corners of the arc chamber 21.

Although the foregoing description has been given with reference to the preferred embodiments of the disclosure, the disclosure is not limited to the configuration of the above-described embodiments.

In addition, it should be understood that the present disclosure can be variously modified and changed by those skilled in the art to which the disclosure pertains without departing from the spirit and scope of the disclosure described in the claims below.

Furthermore, all or part of those embodiments may be selectively combined so that various modifications can be made.
1: DC Relay 10: Frame unit
11: Upper frame 12: Lower frame
13: Insulating plate 14: Supporting plate
20: Opening and closing unit 21: Arc chamber
22: Fixed contact 22a: First fixed contact
22b: Second fixed contact 23: Sealing member
30: Core unit 31: Fixed core
32: Movable core 33: Yoke
34: Bobbin 35: Coil
36: Return spring 37: Cylinder
40: Movable contact unit 41: Housing
42: Cover 43: Movable contact
44: Shaft 45: Elastic portion
100: Arc path formation unit 110: First Halbach array
111: First block 111a: First inner surface
111b: First outer surface 112: Second block
112a: First inner surface 112b: First outer surface
113: Third block 113a: First inner surface
113b: First outer surface 120: Second Halbach array
121: First block 121a: First inner surface
121b: First outer surface 122: Second block
122a: First inner surface 122b: First outer surface
123: Third block 123a: First inner surface
123b: First outer surface 130: First magnetic frame
131: Fitting portion 132: Upper end fixing portion
133: Lower end fixing portion 134: Spacer.
140: Second magnetic frame 141: Fitting portion
142: Upper end fixing portion 143: Lower end fixing portion
144: Spacer A.P: Arc path

1. An arc path formation unit comprising:
a magnetic frame having a space portion formed therein in which a fixed contact and a movable contact are accommodated; and
a Halbach array comprising a plurality of blocks producing magnetic fields in the space portion, arranged adjacent to an inner circumferential surface of the magnetic frame, arranged in parallel in one direction, and formed of a magnetic material,
wherein the Halbach array comprises:
a first block;
a second block arranged to overlap the first block in the one direction; and
a third block located to face the first block with the second block arranged therebetween, and
a surface, facing the third block, of the first block is magnetized with a polarity opposite to that of a surface, facing the first block, of the third block.

2. The arc path formation unit of claim 1, wherein
the Halbach array comprises:
a first Halbach array arranged adjacent to one surface of the magnetic frame; and
a second Halbach array arranged adjacent to another surface of the magnetic frame, and located to face the first Halbach array with the fixed contact and the movable contact arranged therebetween, and
the first Halbach array and the second Halbach array each comprise the first block, the second block, and the third block.

3. The arc path formation unit of claim 2, wherein
the space portion is formed such that a length thereof in the one direction is smaller than a length in another direction,
the first block, the second block, and the third block comprised in the first Halbach array are arranged to overlap in the another direction the first block, the second block, and the third block comprised in the second Halbach array, respectively, and
a surface, facing the second block, of the first block comprised in the first Halbach array is magnetized with a same polarity as that of a surface, facing the second block, of the first block comprised in the second Halbach array.

4. The arc path formation unit of claim 3, wherein
the second block comprised in the first Halbach array and the second block comprised in the second Halbach array are magnetized with opposite polarities on corresponding surfaces thereof facing the fixed contact and the movable contact.

5. The arc path formation unit of claim 3, wherein
the second block comprised in the first Halbach array and the second block comprised in the second Halbach array are magnetized with a same polarity on corresponding surfaces thereof facing the fixed contact and the movable contact.

6. The arc path formation unit of claim 1, wherein
the magnetic frame comprises spacers each arranged on the inner circumferential surface of the magnetic frame between two adjacent blocks of the Halbach array, protruding in a direction away from the inner circumferential surface of the magnetic frame, and formed such that a thickness thereof in the one direction corresponds to a gap between the two adjacent blocks, and
two different spacers are located to face each other with one block comprised in the Halbach array arranged therebetween, the two different spacers having a gap therebetween corresponding to a length of the one block in the one direction.

7. The arc path formation unit of claim 1, wherein
at least one of the first block, the second block, and the third block extends in a direction crossing the one direction.

8. A direct current (DC) relay comprising:
a plurality of fixed contacts located with being spaced apart from each other;
a movable contact brought into contact with or separated from the fixed contacts;
a magnetic frame having a space portion formed therein in which the fixed contacts and the movable contact are accommodated; and
a Halbach array comprising a plurality of blocks producing magnetic fields in the space portion, arranged adjacent to an inner circumferential surface of the magnetic frame, arranged in parallel in one direction, and formed of a magnetic material,
wherein the Halbach array comprises:
a first block;
a second block arranged to overlap the first block in the one direction; and
a third block located to face the first block with the second block arranged therebetween, and
a surface, facing the third block, of the first block is magnetized with a polarity opposite to that of a surface, facing the first block, of the third block.

9. The DC relay of claim 8, wherein
the Halbach array comprises:
a first Halbach array arranged adjacent to one surface of the magnetic frame; and
a second Halbach array arranged adjacent to another surface of the magnetic frame, and located to face the first Halbach array with the fixed contacts and the movable contact arranged therebetween, and
the first Halbach array and the second Halbach array each comprise the first block, the second block, and the third block.

10. The DC relay of claim 9, wherein
the space portion is formed such that a length thereof in the one direction is smaller than a length in another direction,
the first block, the second block, and the third block comprised in the first Halbach array are arranged to overlap in the another direction the first block, the second block, and the third block comprised in the second Halbach array, respectively, and
a surface, facing the second block, of the first block comprised in the first Halbach array is magnetized with a same polarity as that of a surface, facing the second block, of the first block comprised in the second Halbach array.

11. The DC relay of claim 8, wherein
the magnetic frame comprises spacers each arranged on the inner circumferential surface of the magnetic frame between two adjacent blocks of the Halbach array, protruding in a direction away from the inner circumferential surface of the magnetic frame, and formed such that a thickness thereof in the one direction corresponds to a gap between the two adjacent blocks, and
two different spacers are located to face each other with one block comprised in the Halbach array arranged therebetween, the two different spacers having a gap therebetween corresponding to a length of the one block in the one direction.

12. The DC relay of claim 8, wherein
at least one of the first block, the second block, and the third block extends in a direction crossing the one direction.
